(19) United States
(12) Patent Application Publication
(10) Pub. No.: US 2025/0002160 A1
(43) Pub. Date: Jan. 2, 2025

(54) AIRCRAFT COMPRISING A CABIN BLOWER SYSTEM

(71) Applicant: ROLLS-ROYCE plc, London (GB)

(72) Inventors: Marko BACIC, Oxford (GB); Vasileios PACHIDIS, Milton Keynes (GB); Chana A SAIAS, Bedford (GB)

(73) Assignee: ROLLS-ROYCE plc, London (GB)

(21) Appl. No.: 18/754,879

(22) Filed: Jun. 26, 2024

(30) Foreign Application Priority Data
Jun. 28, 2023 (GR) 20230100523

(51) Int. Cl. B64D 13/06; B64D 41/00; F02C 7/32; F04D 17/10; F04D 25/02; F04D 25/06

(52) U.S. Cl. CPC B64D 13/06; B64D 41/00; F02C 7/32; F04D 17/10; F04D 25/02; F04D 25/06; B64D 2013/0611; B64D 2013/0644; B64D 2041/005

(57) ABSTRACT

An aircraft includes a turbofan engine, a cabin blower system and a PEM fuel cell stack. The cabin blower system includes a cabin blower compressor arranged to be driven by mechanical power derived from a shaft of the turbofan engine. A ducting system delivers respective portions of the mass flow rate of compressed air output by the cabin blower system to a cabin space of the aircraft via an air-conditioning unit and to the cathode input of the fuel cell stack. An electric motor receives electrical power from the fuel cell stack and provides mechanical power to the compressor via a drive arrangement of the cabin blower system. Power associated with excess capacity of the cabin blower system is recovered to the cabin blower compressor, thereby mitigating or eliminating the fuel consumption penalty on the turbofan engine associated with the excess capacity.

### CROSS-REFERENCE TO RELATED APPLICATIONS

This application is based upon and claims the benefit of priority from Greek patent application number GR 20230100523, filed on Jun. 28, 2023, the entire contents of which are incorporated herein by reference.

### BACKGROUND OF THE INVENTION

### Field of the Invention

The invention relates to aircraft comprising cabin blower systems and to uses of cabin blower systems.

### Description of Related Art

A cabin blower system is a system which provides ventilation air to a cabin space of an aircraft. A cabin blower system typically forms part of an environmental control system which provides air at appropriate temperature and pressure to a passenger cabin, cockpit or similar cabin space. A cabin blower system of an aircraft may also provide air for further functions, such as wing or engine cowl de-icing or ice protection.

FIG. 1 schematically shows apparatus comprised in an aircraft of the prior art, the apparatus comprising a turbofan engine 1, a cabin blower system 10, a ducting system 20, an air-conditioning system 28 and a cabin 30. The cabin blower system 10 comprises a cabin blower compressor 16 driven by mechanical power derived from the turbofan engine 1 via an off-take shaft or dedicated radial drive 11 engaged with a shaft 5 of the turbofan engine 1 and a transmission 14 having an output shaft 15 coupled to the cabin blower compressor 16. The shaft 5 may be a high-or low-pressure shaft if the turbofan engine 1 is a two-spool engine; alternatively the off-take 11 may be engaged with both high-and low-pressure shafts. The turbofan engine 1 has a fan case 2, a compressor section 3, a turbine section 4 and a combustor section (not shown in FIG. 1 in the interests of clarity). Fan delivery air is provided from the fan case 2 to the cabin blower compressor 16 via a duct 12. (Alternatively, bypass air, ram air or bleed air from early stages of the compressor section 3 may be input to the cabin blower compressor 16). Compressed air output by the cabin blower compressor 16 passes to a heat exchanger 18 via a duct 17 which passes through the heat exchanger 18. The heat-exchanger 18 is arranged to receive fan delivery air from the fan case 2 via a duct 13. Cooled compressed air is provided to an output 19 of the cabin blower system 10 and thence to ducting 20 for onward delivery to the cabin 30 via the air-conditioning system 28, and/or to aircraft parts requiring de-icing or ice protection. The transmission 14 allows the speed of the cabin blower compressor 16 to be controlled independently or substantially independently of the speed of the shaft 5.

FIG. 2, in which parts are labelled with reference signs differing by 50 from those labelling corresponding parts in FIG. 1, shows other aircraft apparatus of the prior art. Mechanical power from a shaft 55 of a turbofan engine 51 is provided via a radial drive 61 to an electrical generator 64A which provides electrical power to an electric motor 64B. The motor 64B provides mechanical power to a cabin blower compressor 66 via an output shaft 5 of the motor 64B.

A significant disadvantage associated with a cabin blower system of the prior art, such as the system 10 of FIG. 1 or the system 60 of FIG. 2, is that it is over-sized for the majority of nominal operating conditions, i.e. it produces a greater mass flow rate of compressed air than is typically required during a flight cycle. In other words the cabin blower system has excess capacity, resulting in a fuel consumption penalty on an engine driving the system. The (normally) excess capacity must however be available in order to meet failure requirements and critical flight conditions which may arise, such as operation in an ice environment and during engine idling. However, operating the cabin blower compressor at a lower capacity penalises the compressor's stability and reduces its efficiency and so does not provide a satisfactory solution to the problem of the fuel consumption penalty. Such operation may not even be possible since the transmission via which a cabin blower compressor is driven may preclude operation of the cabin blower compressor at a speed below that consistent with a minimum level of efficiency. If the transmission is capable of a speed ratio which does allow such operation, it is likely to be of substantial size and to represent a further weight penalty to an aircraft comprising the cabin blower system.

### BRIEF SUMMARY

According to an example, an aircraft comprises:
an internal combustion engine,
a cabin blower system comprising a cabin blower compressor and a drive arrangement engaged with the internal combustion engine and arranged to transmit mechanical power from the internal combustion engine to the cabin blower compressor;
a fuel cell stack comprising at least one fuel cell; and
a ducting system arranged to deliver respective portions of the mass flow rate of compressed air output by the cabin blower compressor to:
   (a) a cabin space of the aircraft; and
   (b) the cathode input of the fuel cell stack.

The aircraft may further comprise an electric motor arranged to receive electrical power from the fuel cell stack, the electric motor being engaged with a shaft of the internal combustion engine and arranged to provide mechanical power to the shaft of the internal combustion engine.

The drive arrangement may comprise a transmission system having an output shaft coupled to the cabin blower compressor and an input shaft engaged with a shaft of the internal combustion engine.

The internal combustion engine may be a gas turbine engine, the input of the transmission system and the electric motor being engaged with a common shaft of the gas turbine engine. Alternatively, the input shaft of the transmission system may be engaged with a first shaft of the gas turbine engine and the electric motor may be engaged with a second shaft of the gas turbine engine, allowing power to be transferred from the first shaft to the second shaft.

Instead of the electric motor being engaged with a shaft of the internal combustion engine and arranged to provide mechanical power to the shaft of the internal combustion engine, the electric motor may be engaged with the drive arrangement and arranged to provide mechanical power to the cabin blower compressor via the drive arrangement. In this case, the drive arrangement may comprise a transmission system having an output shaft coupled to the cabin blower compressor and an input shaft engaged with a shaft of the internal combustion engine, the electric motor being engaged with either the input shaft or the output shaft of the transmission system.

In a further alternative, the electric motor is arranged to provide mechanical power to a fan comprised in a boundary-layer ingestion propulsion arrangement of the aircraft.

The ducting system may comprise a regulator valve, a first duct coupling the output of the cabin blower system to an input of the regulator valve, a second duct coupling a first output of the regulator valve to the cathode input of the fuel cell stack and a third duct coupling a second output of the regulator valve to the cabin space of the aircraft, the regulator valve being operable to control respective proportions of the mass flow rate of compressed air output by the cabin blower system which are delivered to the cabin space and to the cathode input of the fuel cell stack.

The aircraft may further comprise apparatus operable to provide compressed air to the cathode input of the fuel cell stack independently of the cabin blower compressor. Thus, if 100% of the mass flow rate of compressed air output by the cabin blower compressor is directed to the cabin, the fuel cell stack may nevertheless be operated.

The internal combustion engine may be a hydrogen-burning engine, the aircraft further comprising a fuel tank of liquid hydrogen and conveying means arranged to deliver hydrogen fuel from the fuel tank to the internal combustion engine and boiled-off and/or vented gaseous hydrogen from the fuel tank to the anode input of the fuel cell stack.

According to another example, a cabin blower system or cabin blower compressor is used to provide compressed air to the cathode input of a fuel cell stack.

According to a further example, a method of providing compressed air to the cathode input of a fuel cell stack comprised in an aircraft comprises the step of applying a portion of the mass flow rate of compressed air output by a cabin blower system or cabin blower compressor of the aircraft to the cathode output. The method may further comprise the steps of:
(i) providing electrical power from the fuel cell stack to an electric motor to generate mechanical power; and either
(ii) providing the mechanical power to the cabin blower system, or as the case may be, to the cabin blower compressor; or
(iii) where the cabin blower system, or the as the case may be the cabin blower compressor, is driven by mechanical power derived from an internal combustion engine of the aircraft, providing the mechanical power to a shaft of the internal combustion engine.

### BRIEF DESCRIPTION OF THE SEVERAL VIEWS OF THE DRAWINGS

Examples are described below with reference to the accompanying drawings in which:

FIGS. 3, 5 & 7 show first, second and third examples of aircraft apparatus, respectively;

FIGS. 4, 6 & 8 show first, second and third example aircraft respectively, comprising the aircraft apparatus of FIGS. 3, 5 & 7 respectively; and

FIG. 9 shows steps in an example method for providing compressed air to the cathode input of a fuel cell stack.

### DETAILED DESCRIPTION OF THE INVENTION

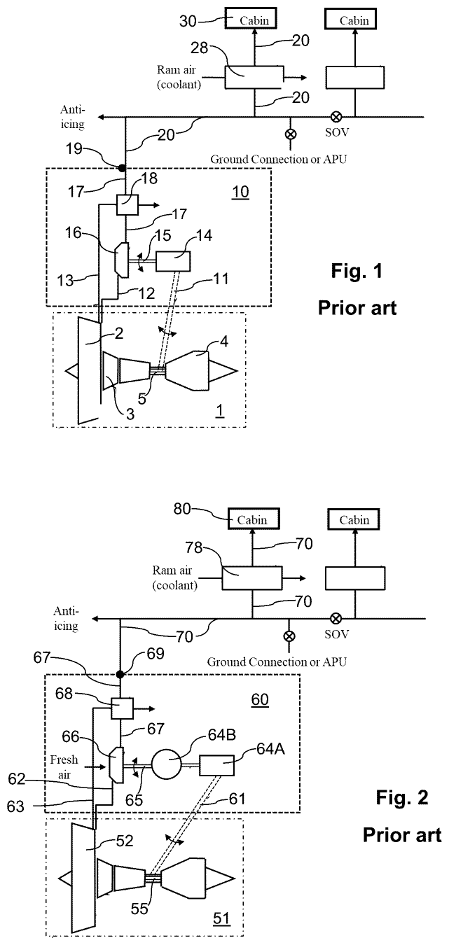

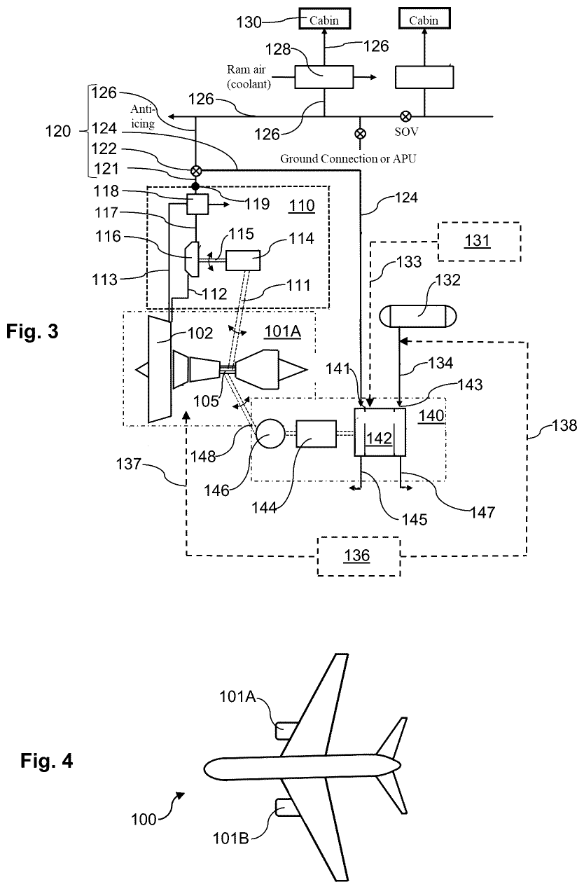

Referring to FIGS. 3 and 4, a first example aircraft 100 of the invention comprises first and second turbofan engines 101A, 101B, a cabin blower system 110, a ducting system 120, an air-conditioning system 128, a cabin 130, a hydrogen fuel tank 132 and a fuel cell system 140 comprising a polymer-electrolyte (proton-exchange) membrane (PEM) fuel cell stack 142 having one or more individual PEM fuel cells. The first turbofan engine 101A comprises a fan case 102 and an engine shaft 105. The cabin blower system 110 comprises a cabin blower compressor 116 (a centrifugal compressor) and a transmission system 114 having input and output shafts 111, 115 engaged with the engine shaft 105 and the cabin blower compressor 116 respectively. In operation of the aircraft 100, compressed air output from the cabin blower compressor 116 is delivered to a system output 119 of the cabin blower system 110 via a duct 117 which passes through a heat-exchanger 118. The cabin blower compressor 116 and the heat-exchanger 118 are supplied with fan delivery air via ducts 112, 113 respectively which are connected to the fan case 102. The heat-exchanger 118 cools the compressed air output by the cabin blower compressor 116 prior to its delivery to the system output 119. The transmission 114 may comprise discrete gears or it may be continuously-variable transmission (CVT). The transmission 114 may be of a type described in patents EP 3034405 B1 or EP 3517436 B1 (i.e. including a mechanical or electrical variator). The transmission 114 allows the speed of the compressor 116 to be controlled independently or substantially independently of the speed of the engine shaft 105. In variants of the aircraft 100, the cabin blower compressor 116 and/or the heat-exchanger 118 are supplied with bypass air of the turbofan engine 101A or with ram air of the aircraft 100.

The ducting system 120 comprises a first duct 121 coupling the system output 119 of the cabin blower system 110 to an input of a regulator valve 122 and second and third ducts 124, 126 coupling first and second outputs of the regulator valve 122 to the fuel cell system 140 and to a cabin 130 of the aircraft 100, via an air-conditioning system 128, respectively. The regulator valve 122 allows the proportions of the mass flow rate of compressed air output by the cabin blower compressor 116 which are provided to the fuel cell system 140 and to the air-conditioning system 128 (or to the air-conditioning system 128 and parts of the aircraft 100 requiring de-icing) to be adjusted. The duct 124 delivers compressed air to the cathode input 141 of the PEM fuel cell stack 142. Hydrogen fuel is provided to the anode input 143 of the PEM fuel cell stack 142 from the hydrogen fuel tank 132 via a duct 134. The fuel cell system 140 further comprises an electric motor 146 arranged to receive electrical power output by the PEM fuel cell stack 142 via a power management system 144 and to provide mechanical power to the engine shaft 105 via an output shaft 148 of the electric motor 146, the output shaft 148 being mechanically engaged with the engine shaft 105.

In operation of the aircraft 100, the mass flow rate of compressed air, output by the cabin blower compressor 116, in excess of that required for ventilation of the cabin 130 is provided to the cathode input 144 of the PEM fuel cell stack 142. The fuel cell system 140 allows power associated with the excess capacity of the cabin blower compressor 216 to be recovered and provided to the turbofan engine 101A, thus mitigating, and possibly eliminating, the fuel consumption penalty on the turbofan engine 101A corresponding to the excess capacity. The PEM fuel cell stack 142 has cathode and anode exhausts 145, 147; cathode exhaust (i.e. hot air and water vapour) may be used for functions such as de-icing, ice protection, fuel heating and oil heating within the aircraft 100. The pressure of compressed air delivered to the cathode input 141 of the PEM fuel cell stack 142 is typically sufficient to allow high-efficiency operation of the PEM fuel cell stack 142, for example much higher efficiency than that achievable using ram air.

The regulator valve 122 allows the proportion of the mass flow rate of compressed air output by the cabin blower system 110 at the system output 119 and delivered to the cathode input 141 of the PEM fuel cell stack 142 to be varied continuously. That proportion may be zero percent if the whole of the mass flow rate of compressed air output by the cabin blower system 110 is required for ventilation of the cabin 130, or for cabin ventilation and de-icing, for example during critical flight conditions. In that case, the cabin blower compressor 116 operates with high efficiency at or close to its design point, and since the full capacity of the cabin blower system 110 is utilised, the cabin blower compressor 116 has no excess capacity and there is no corresponding fuel consumption penalty on the turbofan engine 101A. Nevertheless the fuel cell system 140 may continue to operate if apparatus 131 is present which can provide compressed air to the cathode input 141 of the PEM fuel cell stack 142 via a duct 133 independently of the cabin blower system 110. The apparatus 131 could be a source of ram air or compressor bleed air or bypass air from either or both turbofan engines 201A, 201B. If the apparatus 131 is operable to provide compressed air to the cathode input 141 of the PEM fuel cell stack 142 when the aircraft 100 is stationary on the ground, then the fuel cell system 140 may be used to start the turbofan engine 201A; for example the apparatus 131 may be a small, independently-powered compressor.

Whether or not the apparatus 131 is present, the motor output shaft 148 or the PEM fuel cell stack 142 may be respectively mechanically or electrically disconnectable from the engine shaft 105 or the power management system 144 so that mechanical or electrical power may be delivered to an auxiliary system of the aircraft 100, such as a hydraulic system, pumps, controllers, instrumentation, navigation system etc. The power associated with the excess capacity of the cabin blower system 110 may thus be directed to an auxiliary function, rather than being recovered to the turbofan engine 101A. The fuel cell system 140 may be applied to the auxiliary function during a part or parts of a flight cycle and used to recover power to the turbofan engine 101A during remaining parts of the flight cycle. The fuel cell system 140 may be comprised in the aircraft 100 principally to power one or more auxiliary systems, the arrangement of FIG. 3 being put into effect when it is not required to power an auxiliary system, thus making use of the fuel cell system 140 when it would otherwise be idle and thus simply parasitic weight. If the apparatus 131 is present, the fuel cell system 140 may be utilised, even if the regulator valve 122 is adjusted so that 100% of the mass flow rate of compressed air output by the cabin blower system 110 is directed to the air-conditioning system 128 (and then to the cabin 130), or to the air-conditioning system 128 and parts of the aircraft requiring de-icing or ice protection.

The engine shaft 105 with which the transmission input shaft 111 and the motor output shaft 148 are engaged may be the high-or low-pressure shaft of the turbofan engine 101A where the engine 101A is a two-spool engine. If the turbofan engine 101A is a three-spool engine, the shaft 105 may be a high-, low-or intermediate-pressure shaft of the engine 101A. In a variant of the aircraft 100, the motor output shaft 148 and the transmission input shaft 111 may be coupled to different shafts of the turbofan engine 101A, thus allowing power to be transferred between shafts. For example, if the turbofan engine 101A has two spools, the transmission input shaft 111 may be engaged with the low-pressure shaft of the turbofan engine 101A and the motor output shaft 148 may be engaged with the high-pressure shaft of the turbofan engine 101A. If the turbofan engine 101A has three spools, the transmission input shaft 111 may be engaged with or coupled to the low-, intermediate-or high-pressure shaft of the turbofan engine 101A and the motor output shaft 148 may be engaged with or coupled to one of the other two shafts of the turbofan engine 101A. By making appropriate choices for the engine shafts with which the transmission input shaft 111 and the motor output shaft 148 are engaged, the work split between the shafts may be controlled, improving engine operability and time-on-wing.

The cabin blower compressor 116 runs at or near its maximum capacity, and hence at or near maximum efficiency, for most of an operational period of the aircraft 100. The transmission 114 therefore needs to provide less speed variation than the transmission 14 in an aircraft of the prior art which comprises the arrangement of FIG. 1, allowing the transmission 114 to have smaller physical size and lower weight.

The turbofan engines 101A, 101B may be hydrogen-burning turbofan engines, the aircraft 100 further including a hydrogen fuel store 136 and conveying means 137 for delivering hydrogen fuel from the hydrogen fuel store 136. In this case, hydrogen fuel may also be provided to the anode input 143 of the PEM fuel cell stack 142 from the hydrogen fuel tank 136 via conveying means 138 and the hydrogen fuel store 132 dispensed with. If the hydrogen fuel store 136 stores liquid hydrogen, then gaseous hydrogen resulting from venting of the hydrogen fuel tank 136, or boil-off from the liquid hydrogen stored therein, may be used to supply the PEM fuel cell stack 142, rather than being wasted, as would be the case in the prior art arrangements of FIGS. 1 and 2 where the turbofan engines 1, 51 are hydrogen-burning engines.

In variants of the aircraft 100, the fuel cell stack 142 may be of a type other than a PEM or high-temperature PEM fuel cell stack, provided one of its inputs may use compressed air from the cabin blower compressor 116. The hydrogen fuel store 132 may store gaseous or liquid hydrogen. If the hydrogen fuel store 132 stores liquid hydrogen, further apparatus may be required to vaporise stored liquid hydrogen prior to its input to the anode input 143 of the PEM fuel cell stack 142. Similarly, if the turbofan engine 101A is a hydrogen-burning engine, further apparatus may be required to vaporised liquid hydrogen store in the hydrogen fuel store 136 prior to its input to the combustor of the turbofan engine 101A.

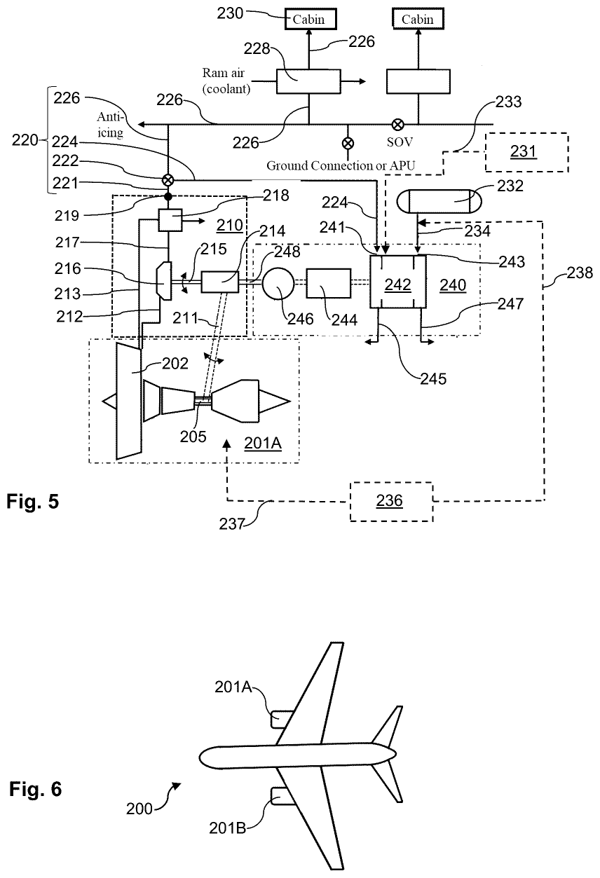

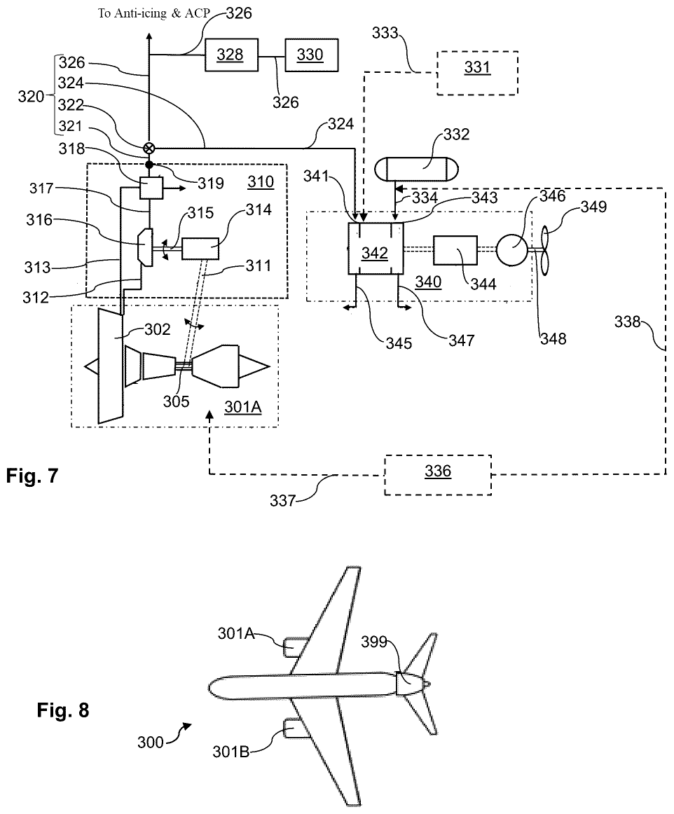

Referring to FIGS. 5 and 6, in which parts are labelled with reference numerals differing by 100 from those labelling corresponding parts in FIGS. 3 and 4, a second example aircraft 200 comprises turbofan engines 201A, 201B, a cabin blower system 210, a ducting system 220 and a cabin 230. Output shaft 248 of electric motor 246, which is comprised in fuel cell system 240, is either engaged with the input of transmission system 214 together with transmission input shaft 211, or with the output of the transmission system 214, in which case the motor output shaft 248 may be directly coupled to transmission output shaft 215.

The arrangement of FIG. 5 operates similarly to the arrangement of FIG. 3, except that power associated with the excess capacity of cabin blower compressor 216 is recovered to the cabin blower compressor 216 itself, rather than to turbofan engine 201A, in order to mitigate or eliminate the fuel consumption penalty on the turbofan engine 201A associated with the excess capacity.

During descent of the aircraft 200 from cruise conditions, input shaft 211 may be disengaged with engine shaft 204 such that cabin blower compressor 216 is power entirely by fuel cell system 240. Alternatively, the fuel cell system 240 may provide mechanical power to both cabin blower system 210 and to turbofan engine 201A.

Referring to FIGS. 7 and 8, in which parts are labelled with reference numerals differing by 200 from those labelling corresponding parts in FIGS. 3 and 4, a third example aircraft 300 comprises turbofan engines 301A, 301B, a cabin blower system 310, a ducting system 320, a fuel cell system 340 and a boundary-layer ingestion (BLI) propulsion system 399 which comprises a BLI fan 349. In operation of the aircraft 300, the fuel cell system 340 provides mechanical power to the BLI fan 349. Power associated with the excess capacity of the cabin blower system 310 is thus applied to driving the BLI fan, rather than being recovered to either the turbofan engine 301A or to cabin blower compressor 316. Additional fuel consumption of the turbofan engine 301A associated with excess capacity of the cabin blower compressor 316 is thus usefully employed in driving the BLI fan 349, rather than being wasted, as in the prior art, or used to mitigate or eliminate a fuel consumption penalty on the turbofan engine 301A, as in the case of the arrangements of FIGS. 3 and 5.

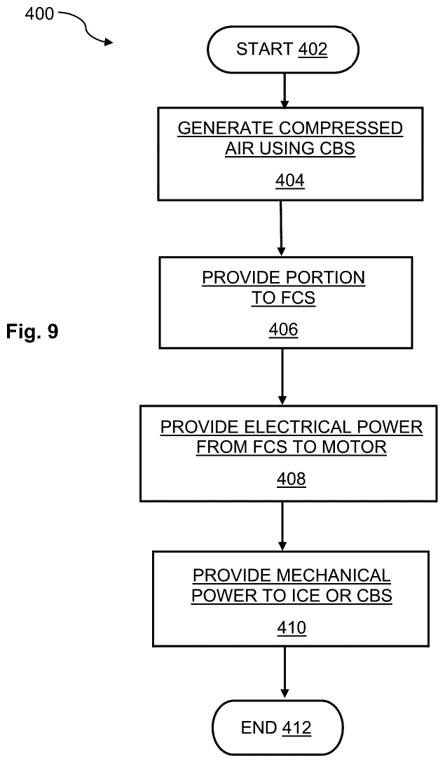

FIG. 9 shows a flowchart illustrating steps in a method 400 of providing compressed air to the cathode input of a fuel cell stack comprised in an aircraft. Following starting 402 of the method, compressed air is generated 404 using a cabin blower system (CBS) of the aircraft. A portion of the mass flow rate of compressed air output by the cabin blower system is provided 406 to the cathode input of the fuel cell stack. Electrical power generated by the fuel cell stack is provided 408 to an electric motor. Mechanical power from the electric motor is provided 410 to a shaft of an internal combustion engine (such as a gas turbine engine), a portion of the mechanical output power of which is provided to the cabin blower system in order to drive it. The method then ends 412.

1-15. (canceled)

16. An aircraft comprising:
an internal combustion engine;
a cabin blower system comprising a cabin blower compressor and a drive arrangement engaged with the internal combustion engine and arranged to transmit mechanical power from the internal combustion engine to the cabin blower compressor;
a fuel cell stack comprising at least one fuel cell; and
a ducting system arranged to deliver respective portions of the mass flow rate of compressed air output by the cabin blower compressor to:
(a) a cabin space of the aircraft; and
(b) the cathode input of the fuel cell stack.

17. The aircraft according to claim 16 further comprising an electric motor arranged to receive electrical power from the fuel cell stack, the electric motor being engaged with a shaft of the internal combustion engine and arranged to provide mechanical power to the shaft of the internal combustion engine.

18. The aircraft according to claim 17 wherein the drive arrangement comprises a transmission system having an output shaft coupled to the cabin blower compressor and an input shaft engaged with a shaft of the internal combustion engine.

19. The aircraft according to claim 18 wherein the internal combustion engine is a gas turbine engine, and the input of the transmission system and the electric motor are engaged with a common shaft of the gas turbine engine.

20. The aircraft according to claim 18 wherein the internal combustion engine is a gas turbine engine, the input shaft of the transmission system is engaged with a first shaft of the gas turbine engine and the electric motor is engaged with a second shaft of the gas turbine engine.

21. The aircraft according to claim 16 further comprising an electric motor arranged to receive electrical power from the fuel cell stack, wherein the electric motor is engaged with the drive arrangement and arranged to provide mechanical power to the cabin blower compressor via the drive arrangement.

22. The aircraft according to claim 21 wherein the drive arrangement comprises a transmission system having an output shaft coupled to the cabin blower compressor and an input shaft engaged with a shaft of the internal combustion engine and wherein the electric motor is engaged with either the input shaft or the output shaft of the transmission system.

23. The aircraft according to claim 16 and further comprising an electric motor arranged to receive electrical power from the fuel cell stack and provide mechanical power to a fan comprised in a boundary-layer ingestion propulsion arrangement of the aircraft.

24. The aircraft according to claim 16 wherein the ducting system comprises a regulator valve, a first duct coupling the output of the cabin blower system to an input of the regulator valve, a second duct coupling a first output of the regulator valve to the cathode input of the fuel cell stack and a third duct coupling a second output of the regulator valve to the cabin space of the aircraft, wherein the regulator valve is operable to control respective proportions of the mass flow rate of compressed air output by the cabin blower system which are delivered to the cabin space and to the cathode input of the fuel cell stack.

25. The aircraft according to claim 16 further comprising apparatus operable to provide compressed air to the cathode input of the fuel cell stack independently of the cabin blower compressor.

26. The aircraft according to claim 16 wherein the internal combustion engine is a hydrogen-burning engine and the aircraft further comprises a fuel tank of liquid hydrogen and conveying means arranged to deliver hydrogen fuel from the fuel tank to the internal combustion engine and boiled-off and/or vented gaseous hydrogen from the fuel tank to the anode input of the fuel cell stack.

27. Utilizing a cabin blower system or a cabin blower compressor to provide compressed air to the cathode input of a fuel cell stack.

28. A method of providing compressed air to the cathode input of a fuel cell stack comprised in an aircraft, the method comprising the step of applying a portion of the mass flow rate of compressed air output by a cabin blower system or cabin blower compressor of the aircraft to the cathode input.

29. The method according to claim 28 further comprising the steps of:
(i) providing electrical power from the fuel cell stack to an electric motor to generate mechanical power; and
(ii) providing the mechanical power to the cabin blower system or as the case may be to the cabin blower compressor.

30. A method according to claim 28 wherein the cabin blower system, or the as the case may be the cabin blower compressor, is driven by mechanical power derived from an internal combustion engine of the aircraft and the method further comprises the steps of:
(i) providing electrical power from the fuel cell stack to an electric motor to generate mechanical power; and
(ii) providing the mechanical power to a shaft of the internal combustion engine.
